(19) United States
(12) Patent Application Publication
(10) Pub. No.: US 2022/0252267 A1
(43) Pub. Date: Aug. 11, 2022

(54) COMBUSTOR OF GAS TURBINE ENGINE

(71) Applicant: TOYOTA JIDOSHA KABUSHIKI KAISHA, Toyota-shi (JP)

(72) Inventors: Yoshito IKEUCHI, Gotemba-shi (JP); Shunsuke KASUGA, Numazu-shi (JP)

(73) Assignee: TOYOTA JIDOSHA KABUSHIKI KAISHA, Toyota-shi (JP)

(21) Appl. No.: 17/584,760

(22) Filed: Jan. 26, 2022

(30) Foreign Application Priority Data
Feb. 5, 2021 (JP) 2021-017861

(51) Int. Cl. F23R 3/34; F02C 7/232; F23N 1/00

(52) U.S. Cl. CPC F23R 3/343; F02C 7/232; F23N 2225/08; F23N 2225/04; F23N 1/002

(57) ABSTRACT

A combustor of a gas turbine engine includes a combustion chamber, pilot fuel supply unit configured to supply solely auxiliary fuel to a flame holding region in the combustion chamber, first auxiliary fuel amount adjustment unit configured to adjust an amount of the auxiliary fuel supplied from the pilot fuel supply unit, main fuel supply unit configured to supply unburned gas and the auxiliary fuel to an unburned gas combustion region in the combustion chamber continuous with the flame holding region, and second auxiliary fuel amount adjustment unit configured to adjust an amount of the auxiliary fuel, in which the first auxiliary fuel amount adjustment unit is configured to adjust the amount of the auxiliary fuel supplied from the pilot fuel supply unit to an amount for flame holding in the flame holding region throughout an operation of the gas turbine engine.

### CROSS-REFERENCE TO RELATED APPLICATION

This application claims priority to Japanese Patent Application No. 2021-017861 filed on Feb. 5, 2021, incorporated herein by reference in its entirety.

### BACKGROUND

### 1. Technical Field

The present disclosure relates to a gas turbine engine, and more particularly to a combustor of a gas turbine engine used for processing unburned gas.

### 2. Description of Related Art

As one method for processing unburned gas in gas discharged from factories or various industrial machines, for example, gas having room for combustion, such as exhaust gas from a coke oven, VOC gas, CO, HC, or NO, a configuration is known in which the unburned gas is combusted as a fuel of a gas turbine engine, and energy obtained by combustion is recovered as electric energy or mechanical energy. In such a configuration, as described above, the unburned gas generally has a small calorific value and is difficult to stably drive the gas turbine engine by itself. Therefore, normally, the unburned gas is mixed with a fuel (auxiliary fuel, combustion aid fuel) having a higher calorific value and supplied to the gas turbine engine. In such a technique, for example, in Japanese Unexamined Patent Application Publication No. 2010-216319 (JP 2010-216319 A), as a configuration in which in order to process blast furnace gas having a low calorific value generated in a blast furnace during an iron manufacturing process, gas in which blast furnace gas and the combustion aid fuel, such as coke oven gas having a higher calorific value, are mixed is used as a fuel of a gas turbine engine, a configuration is proposed in which a flow rate of a plurality of types of the fuel gas having different calorific values is adjusted to suppress a usage amount of the combustion aid fuel to a minimum amount based on a temperature of the fuel gas after mixing and compression and a gas turbine load. In addition, in the configuration in JP 2010-216319 A, when the gas turbine engine is activated, the gas turbine engine is rotated with a fuel for activation, such as light oil, the rotation of the gas turbine engine reaches non-load rated rotation speed, and then the supplied gas is switched to gas in which the blast furnace gas and the combustion aid fuel (coke oven gas) are mixed.

### SUMMARY

As described above, in a configuration in which unburned gas is processed and energy is recovered by supplying the unburned gas as a fuel of a gas turbine engine and combusting the supplied unburned gas, from the viewpoints of effective use of a resource, decrease in a running cost, and the like, it is desirable that an amount of an auxiliary fuel used together with the unburned gas can be decreased as small as possible in combustion processing. In this regard, in order to stably operate the gas turbine engine, in a combustor, a ratio (equivalent ratio) of an air flow rate and a fuel component needs to be an equivalent ratio suitable for flame holding such that blowout is not caused. However, in a case where the unburned gas and the auxiliary fuel are mixed in a supply line and the mixture is supplied to a combustion chamber as in the configuration in JP 2010-216319 A, the unburned gas and the auxiliary fuel are supplied in a mixed state from a fuel nozzle, and thus it is difficult to decrease the amount of the auxiliary fuel to the minimum amount. In addition, in order for the gas turbine engine to continue to be rotated stably, or to handle a load fluctuation in response to a load request (power generation request and the like) for the gas turbine engine, it is desirable that the amount of the auxiliary fuel supplied to the combustion chamber can be increased or decreased while a flame holding state is maintained.

Therefore, the present disclosure is to provide a configuration in which in order to process the unburned gas, the amount of the auxiliary fuel supplied to the combustor together with the unburned gas can be decreased as small as possible in the combustor of the gas turbine engine in which the unburned gas is supplied as the fuel.

In addition, the present disclosure is to provide a configuration that enables decrease the amount of auxiliary fuel for flame holding as small as possible in the combustor of the gas turbine engine as described above.

An aspect of the present disclosure relates to a combustor of a gas turbine engine in which unburned gas and an auxiliary fuel are supplied and combusted. The combustor includes a combustion chamber in which the unburned gas, the auxiliary fuel, and compressed air are supplied, and the unburned gas and the auxiliary fuel are combusted, a pilot fuel supply unit configured to supply solely the auxiliary fuel to a flame holding region in the combustion chamber, a first auxiliary fuel amount adjustment unit configured to adjust an amount of the auxiliary fuel supplied from the pilot fuel supply unit, a main fuel supply unit configured to supply the unburned gas and the auxiliary fuel to an unburned gas combustion region in the combustion chamber continuous with the flame holding region, and a second auxiliary fuel amount adjustment unit configured to adjust an amount of the auxiliary fuel supplied from the main fuel supply unit. The first auxiliary fuel amount adjustment unit is configured to adjust the amount of the auxiliary fuel supplied from the pilot fuel supply unit to an amount for flame holding in the flame holding region throughout an operation of the gas turbine engine.

In the configuration described above, the “gas turbine engine” may be any type of a gas turbine engine configured to rotationally drive the turbine by gas having a high temperature and a high pressure obtained by the combustion of the fuel and the compressed air in the combustor to obtain a rotation force and drive a compressor that compresses the air supplied to the combustor. As described above, the “unburned gas” may be various gas having room for combustion in exhaust gas of industrial machines or transportation machines of facilities, such as factories. The “auxiliary fuel” may be a fuel normally used as a fuel for the gas turbine engine, or may be a gas fuel, such as city gas, or a liquid fuel, such as kerosene. The “compressed air” is supplied to the combustion chamber in any aspect by compressing the air taken in from the atmosphere by the compressor and delivering the compressed air. The “combustion chamber” may be a chamber of a normal aspect in which the fuel and the compressed air are mixed and combusted in the combustor of the gas turbine engine, and mainly includes, inside the chamber, the “flame holding region” that is a region in which the fuel supplied from the “pilot fuel supply unit” is dispersed and the “unburned gas combustion region” that is a region in which the fuel supplied from the “main fuel supply unit” is dispersed. Here, as described above, the “flame holding region” is a region in which the auxiliary fuel is given by the pilot fuel supply unit such that the flame is held throughout the operation of the gas turbine engine, and the “unburned gas combustion region” is a region in which the unburned gas or the unburned gas and the auxiliary fuel are given and combusted. “Throughout the operation of the gas turbine engine” refers to an operation state including a state where the gas turbine engine is activated and a state where a rotational operation is stably continued thereafter. The “pilot fuel supply unit” may be any type of a nozzle that injects or sprays the auxiliary fuel into the “flame holding region”, and the “main fuel supply unit” may be any type of a nozzle that injects or sprays the unburned gas and the auxiliary fuel into the “unburned gas combustion region”. The unburned gas and the auxiliary fuel may be appropriately mixed and delivered in the main fuel supply unit. The “first auxiliary fuel amount adjustment unit” and the “second auxiliary fuel amount adjustment unit” may be any unit that adjusts the amount of the auxiliary fuel (auxiliary fuel flame holding flow rate) supplied from the pilot fuel supply unit and the amount of the auxiliary fuel (auxiliary fuel extra flow rate) supplied from the main fuel supply unit, respectively, and may be a valve for adjusting a flow amount of a pipe through which the fuel is supplied, for example. Then, the first auxiliary fuel amount adjustment unit adjusts the amount of the auxiliary fuel supplied from the pilot fuel supply unit to the amount for flame holding in the flame holding region throughout the operation of the gas turbine engine.

In the configuration described above of the combustor according to the aspect of the present disclosure, solely the auxiliary fuel is supplied to the “flame holding region” of the combustion chamber, and the flame is held throughout the operation of the gas turbine. With such a configuration, regardless of a state of the unburned gas supplied to the combustion chamber or even in a case where the total amount of the auxiliary fuel supplied due to the load fluctuation of the gas turbine engine is increased or decreased, the flame is held in the combustion chamber, and thus a combustion state in the combustion chamber is maintained. In addition, since the fuel dispersed in the flame holding region is approximately the auxiliary fuel having a large calorific value, in the equivalent ratio requested for flame holding the amount of the auxiliary fuel with respect to an amount of the compressed air can be decreased compared to when the unburned gas having a lower calorific value is present. In addition, since the flame is held in the flame holding region, the unburned gas having a lower calorific value is easily combusted even in the unburned gas combustion region continuous with the flame holding region. Therefore, in the configuration described above of the present disclosure, solely the auxiliary fuel is supplied as the fuel to the combustion chamber, and the flame holding region in which the flame is held even in various operation states is formed, so that the amount of the auxiliary fuel needed for maintaining the combustion state can be decreased without causing the blowout in the combustion chamber. The configurations (geometry) of the pilot fuel supply unit and the flame holding region are appropriately designed such that the flame can be held with a smaller amount of the auxiliary fuel. Typically, in the combustion chamber, the unburned gas combustion region may surround the flame holding region such that the flame in the flame holding region is easily transferred evenly to the unburned gas combustion region.

In the configuration described above of the combustor according to the aspect of the present disclosure, since the fuel supplied to the flame holding region is substantially solely the auxiliary fuel, the amount of the auxiliary fuel for achieving the equivalent ratio needed for the flame holding in the flame holding region, that is, the auxiliary fuel flame holding flow rate can be decided in response to the amount of the air flowing through the flame holding region. Since the geometrical configuration of the flame holding region in the combustion chamber is decided by the design, the amount of the air flowing through the flame holding region is a function of a pressure and a temperature of the compressed air at an inlet in the combustion chamber. Therefore, the auxiliary fuel flame holding flow rate may be decided based on the pressure and the temperature of the compressed air at the inlet in the combustion chamber. In the aspect, a map for deciding the auxiliary fuel flame holding flow rate in response to the pressure and the temperature of the compressed air at the inlet in the combustion chamber may be prepared in advance by an experiment and the like, the auxiliary fuel flame holding flow rate may be decided by using the map with reference to measured values of the pressure and the temperature of the compressed air at the inlet in the combustion chamber when the gas turbine is operated, and the first auxiliary fuel amount adjustment unit may adjust the auxiliary fuel supplied from the pilot fuel supply unit to such an auxiliary fuel flame holding flow rate. In addition, as described above, for the effective use of the resource and the decrease in the running cost, a supply amount of the auxiliary fuel should be decreased as small as possible, and further, for stable combustion and decrease in NOx and CO, the ratio of the fuel desirably low as low as possible. Therefore, the auxiliary fuel flame holding flow rate supplied from the pilot fuel supply unit may be a minimum amount needed for flame holding in the flame holding region. The auxiliary fuel flame holding flow rate may be an amount obtained by adding a predetermined amount (that can be appropriately set) to such a minimum amount as long as the action and effect of the present disclosure and a case of the minimum amount are approximately not affected, and it should be understood that such cases also fall within the scope of the present disclosure.

Further, in the configuration described above of the combustor according to the aspect of the present disclosure, the total amount of the fuel to be supplied to the combustion chamber (sum of the total amount of the auxiliary fuel and the total amount of unburned gas) is decided in response to the operation state of the gas turbine engine. For example, in a case where the main purpose is to process the unburned gas, the fuel (auxiliary fuel and unburned gas) need only be supplied to the combustion chamber such that the fuel is sufficient to combust the unburned gas and the gas turbine engine can maintain the stable rotation state. Alternatively, in a case where an output of the gas turbine engine is used for various applications, when the load of the gas turbine engine is controlled in response to a request of the output from the applications, the fuel may be supplied to the combustion chamber such that the requested output amount can be achieved. On the other hand, it is desirable to control the amount of the fuel supplied to the combustion chamber such that the temperature of the combustion chamber is not excessively high. A temperature of the combustion chamber is affected by the temperature of the compressed air at the inlet, the temperature of the unburned gas, or the like (more specifically, the temperature of the combustion chamber is mostly estimated as a value obtained by adding a temperature rise of the temperature due to the calorific value generated by the combustion of the fuel to the temperature of the compressed air). Therefore, the total amount of the fuel to be supplied to the combustion chamber may be decided by any method in response to a usage status of the gas turbine engine based on an output state of the gas turbine engine, for example, a rotation speed, an output torque, and the temperature of the combustion chamber, such that the desired rotation state of the gas turbine engine is achieved and the temperature of the combustion chamber is not excessively high. Since it is normally difficult to directly measure the temperature of the combustion chamber, in the aspect, the total amount of the fuel to be supplied to the combustion chamber may be decided with reference to the pressure and the temperature at the inlet of the combustion chamber, that are a determinant of the temperature of the combustion chamber.

In such a configuration, the total amount of the auxiliary fuel to be supplied to the combustion chamber is decided based on the total amount of the fuel to be supplied to the combustion chamber and the supply amount of the unburned gas, but the amount of the auxiliary fuel supplied from the pilot fuel supply unit is decided based on the pressure and the temperature of the compressed air at the inlet of the combustion chamber as described above. Therefore, the amount of the auxiliary fuel supplied from the main fuel supply unit may be an amount obtained by subtracting the amount of the auxiliary fuel supplied from the pilot fuel supply unit from the total amount of the auxiliary fuel to be supplied to the combustion chamber. In addition, since the calorific value per unit amount differs between the auxiliary fuel and the unburned gas, the total amount of the auxiliary fuel to be supplied to the combustion chamber may be the amount of the fuel equivalent to the calorific value obtained by subtracting the calorific value of the unburned gas supplied from the main fuel supply unit from the total calorific value of the fuel to be supplied to the combustion chamber. As a result, it is expected that the auxiliary fuel will be supplied to the flame holding region and the unburned gas combustion region in a more appropriate amount in response to the usage status of the gas turbine engine.

In the control of the supply amount of the auxiliary fuel described above, since the amount of the auxiliary fuel supplied from the pilot fuel supply unit is decided in response to the pressure and the temperature of the compressed air at the inlet in the combustion chamber for flame holding, when the load of the gas turbine engine fluctuates, the amount of the auxiliary fuel supplied from the main fuel supply unit is changed. Therefore, in the combustor according to the aspect of the present disclosure, the amount of the auxiliary fuel supplied from the main fuel supply unit may be increased or decreased in response to the load of the gas turbine engine.

In the configuration described above, when the flow rate can be directly measured, the supply amount of the unburned gas may be measured by the flow rate, but in a case where it is difficult to directly measure the flow rate, the supply amount of the unburned gas may be estimated from parameters (temperature, pressure, and the like) having a correlation with the flow rate of the unburned gas. In addition, in the configuration described above, in a case where a course of an inflow of the unburned gas to the combustion chamber is excessive, for example, in a case where the calorific value in response to the inflow of the unburned gas exceeds the calorific value equivalent to the amount obtained by subtracting the auxiliary fuel flame holding flow rate from the total amount of the fuel to be supplied to the combustion chamber, it is desirable that the inflow of the unburned gas to the combustion chamber can be limited. Therefore, in the combustor according to the aspect of the present disclosure described above, an unburned gas adjustment unit configured to adjust the amount of the unburned gas supplied from the main fuel supply unit may be provided, and the inflow of the unburned gas to the combustion chamber may be appropriately controllable. The unburned gas adjustment unit may be a valve for adjusting the flow amount of the pipe through which the unburned gas is supplied.

Therefore, according to the present disclosure described above, in the combustor having the configuration in which the unburned gas is processed by the gas turbine engine, regardless of the state of the unburned gas or the load fluctuation of the gas turbine engine, by configuring the flame holding region in which solely the auxiliary fuel is supplied to hold the flame in the combustion chamber, a usage amount of the auxiliary fuel for flame holding can be decreased, and the effective use of the resource and the decrease in the running cost are further expected in the processing of the unburned gas and the recovery of the energy. In addition, in the configuration of the present disclosure, in the decision of the amount of the fuel for flame holding in the combustion chamber, the equivalent ratio in the flame holding region in which solely the auxiliary fuel is supplied need only be considered, and it is expected that the decision of the amount of the fuel needed for flame holding can be more easily made than a case where the supply amount of the auxiliary fuel is decided such that the blowout is not caused in a state the unburned gas having different calorific value is mixed in the auxiliary fuel. Further, in a case where the load of the gas turbine engine fluctuates, in the end, apart from the amount of the fuel for flame holding, the amount of the auxiliary fuel supplied to the unburned gas combustion region need only be increased or decreased in response to the load of the gas turbine engine, and it is expected that the amount of the auxiliary fuel will be easily controlled. The configuration of the present disclosure may be advantageously used for processing the exhaust gas from industrial machines or transportation machines of facilities, such as factories.

Other objects and advantages of the present disclosure will be clear from the following description of preferred embodiments of the present disclosure.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1A is a schematic diagram showing a schematic configuration of a gas turbine engine to which a combustor according to the present embodiment is applied;

FIG. 1B is a diagram showing a schematic configuration of one aspect of the combustor according to the present embodiment;

FIG. 2 is a block diagram showing a configuration of one aspect of a process of deciding a supply flow rate of an auxiliary fuel in the combustor according to the present embodiment;

FIG. 3 is a block diagram showing a configuration of another aspect of the process of deciding the supply flow rate of the auxiliary fuel in the combustor according to the present embodiment;

FIG. 4A is a diagram showing a schematic configuration of another aspect of the combustor according to the present embodiment; and

FIG. 4B is a block diagram showing a configuration of one aspect of the process of deciding the supply flow rate of the auxiliary fuel in the combustor in the aspect of FIG. 4A.

### DETAILED DESCRIPTION OF EMBODIMENTS

Configuration of Gas Turbine Engine

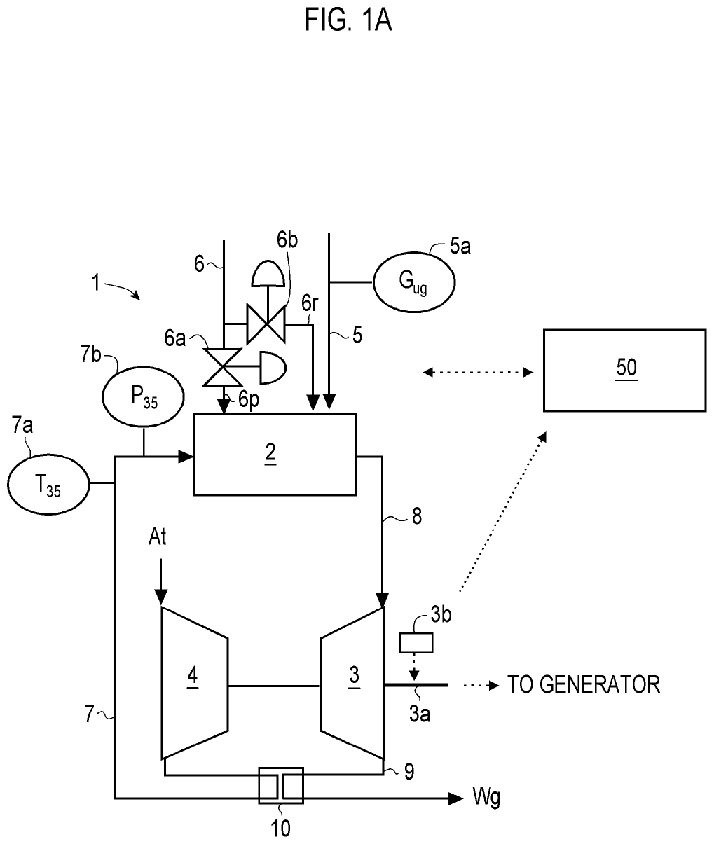

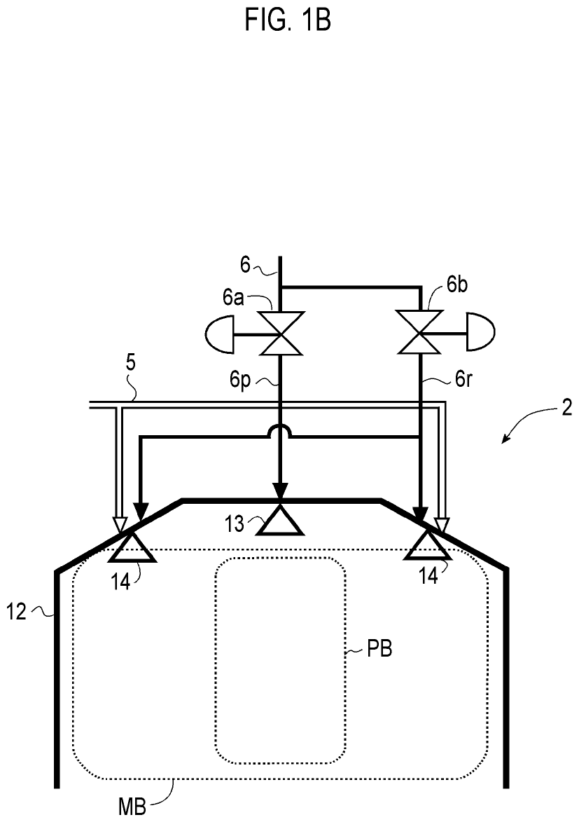

With reference to FIG. 1A, a combustor according to the present embodiment is applied to a gas turbine engine 1 in which unburned gas is supplied as a part of a fuel for processing the unburned gas. The gas turbine engine 1 includes a combustor 2, a turbine 3, and a compressor 4, similar to a normal gas turbine engine in the related art used in this field. In the combustor 2, as the fuel, the unburned gas is supplied from a unburned gas supply line 5 and an auxiliary fuel is supplied from an auxiliary fuel supply line 6 (6p, 6r), these fuels are combusted by using compressed air supplied from a compressed air supply line 7 from the compressor 4, and the combustion gas having a high temperature and a high pressure is delivered to a combustion gas delivery line 8. As described in the “SUMMARY” column, the unburned gas may be any gas having room for combustion in exhaust gas in industrial machines or transportation machines of facilities, such as factories, for example, exhaust gas from a coke oven, VOC gas, CO, HC, or NO. Since the unburned gas described above generally has a small calorific value, the auxiliary fuel having a larger calorific value is supplied such that the gas turbine engine can be reliably operated. As described above, the auxiliary fuel may be a fuel normally used as a fuel for the gas turbine engine, or may be a gas fuel, such as city gas, or a liquid fuel, such as kerosene. The turbine 3 is rotated by the combustion gas from the combustion gas delivery line 8, and the compressor 4 is rotated due to the rotation, compresses air At taken in from the atmosphere, and delivers the compressed air At to the compressed air supply line 7. In addition, any machine equipment (not shown), typically, a generator is connected to a rotation shaft 3a of the turbine 3, and rotational energy of the turbine 3 is recovered by the machine equipment, such as the generator or is used as energy for an operation of the machine. In addition, since the exhaust gas discharged from the turbine 3 has a high temperature, a configuration may be adopted in which heat energy thereof is used to raise a temperature of the compressed air given to the combustor 2, an exhaust line 9 through which the exhaust gas flows and the compressed air supply line 7 pass through a heat exchanger 10, and the heat energy of the exhaust gas is transferred to the compressed air such that the energy efficiency can be improved. As will be described below, in order to control a flow rate of the auxiliary fuel supplied to the combustor 2 and a flow rate of the unburned gas, a temperature T₃₅ and a pressure P₃₅ of the compressed air at an inlet of the combustor 2 may be measured by a temperature measuring instrument 7a and a pressure measuring instrument 7b, respectively, and an unburned gas flow rate G_{ug} and an unburned gas temperature T_{ug} may be measured by a flow rate measuring instrument 5a and a temperature measuring instrument (not shown), respectively.

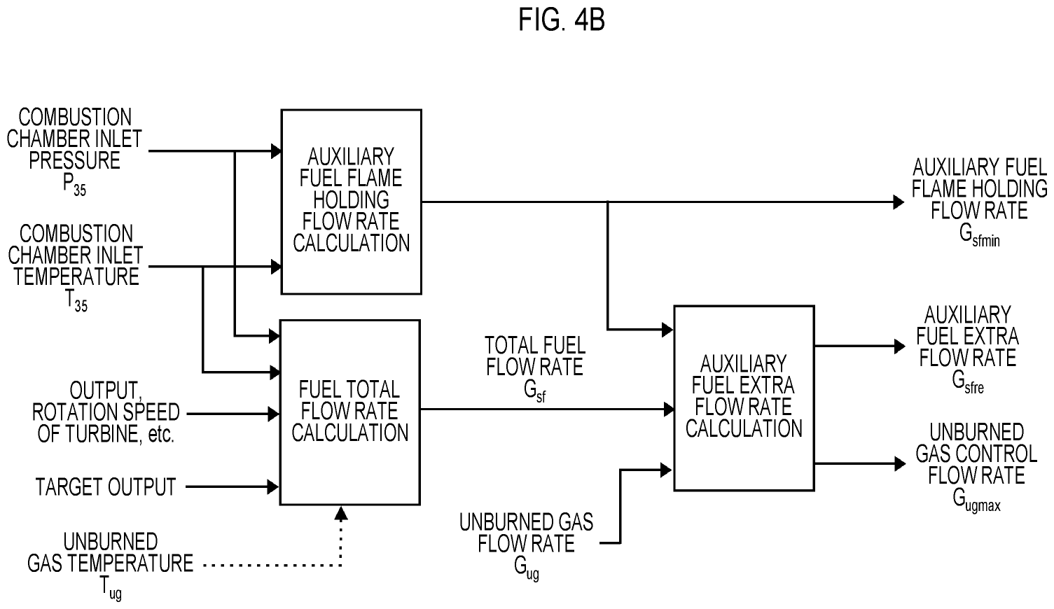

In the configuration described above, a control of a supply amount of the auxiliary fuel is executed by a control device 50. The control device 50 may be configured by a computer device including a computer having a CPU, a ROM, a RAM and an input/output port device connected to each other by a bidirectional common bus in a normal type and a drive circuit, and the operation of the control device 50 may be realized by an operation of the computer device in response to a program. The control device 50 may be configured to adjust the flow rate of the auxiliary fuel in a pilot auxiliary fuel flow rate control valve 6a and an auxiliary fuel extra flow rate control valve 6b to be described below with reference to a state of the compressed air from the temperature measuring instrument 7a and the pressure measuring instrument 7b, the flow rate and the temperature of the unburned gas from the flow rate measuring instrument 5a and the temperature measuring instrument (not shown) respectively, a rotation speed and a torque of the turbine 3 from a turbine rotation measuring instrument 3b that detects an output of the turbine, and the like (further, in another embodiment as will described below, the flow rate of the unburned gas may be controlled by an unburned gas flow rate control valve 5b (see FIG. 4A)).

Configuration of Combustor

More specifically, as shown in FIG. 1B, the combustor 2 according to the present embodiment is configured in which in a combustion chamber 12, the unburned gas is supplied from the unburned gas supply line 5 and the auxiliary fuel is supplied from the auxiliary fuel supply line 6, the compressed air flows in from the compressed air supply line 7 (not shown in FIG. 1B), and the unburned gas and the auxiliary fuel are combusted. In such a configuration, a configuration is adopted in which the auxiliary fuel supply line 6 is divided into an auxiliary fuel flame holding flow rate supply line 6p connected to a pilot auxiliary fuel supply nozzle 13 (pilot fuel supply unit) and an auxiliary fuel extra flow rate supply line 6r connected to an auxiliary fuel and unburned gas supply nozzle 14 (main fuel supply unit), the pilot auxiliary fuel extra flow rate control valve 6a and the auxiliary fuel extra flow rate control valve 6b are provided in these lines, respectively, and the flow rate of the auxiliary fuel supplied to each nozzle is controlled. In addition, the unburned gas supply line 5 may be further connected to the auxiliary fuel and unburned gas supply nozzle 14, typically, the unburned gas and the auxiliary fuel may be appropriately mixed and supplied from the auxiliary fuel and unburned gas supply nozzle 14. The supply of the fuel from the pilot auxiliary fuel supply nozzle 13 and the auxiliary fuel and unburned gas supply nozzle 14 may be achieved by injecting or spraying each fuel such that the fuel is appropriately dispersed (however, the aspect of the supply of the fuel is not limited thereto). Then, inside the combustion chamber 12, a structure of the combustion chamber 12 is designed and formed such that the auxiliary fuel from the pilot auxiliary fuel supply nozzle 13 is supplied so as to be mostly dispersed over a region PB and the auxiliary fuel and the unburned gas from the auxiliary fuel and unburned gas supply nozzle 14 are supplied so as to be mostly dispersed over a region MB. In FIG. 1B, the region PB is drawn so as to overlap with the region MB, but actually, the combustion chamber 12 has a mostly tubular structure, and the region PB and the region MB are divided such that boundaries thereof are in contact with each other. Typically, as will described below, the region MB may surround the region PB such that the flame generated in the region PB is transferred to the region MB as evenly as possible.

In the configuration of the combustor 2 described above, substantially solely the auxiliary fuel is dispersed in the region PB, and the unburned gas having a calorific value smaller than that of the auxiliary fuel is dispersed in the region MB. Then, in the region PB, throughout the operation of the gas turbine engine, that is, in the normal operation state in addition to when the engine is activated, in particular, even in a state where the load of the gas turbine engine can fluctuate widely, the auxiliary fuel is supplied such that the flame is held, as a result, the flame in the region PB is transferred to the region MB, and in the region MB, the unburned gas is reliably combusted. Therefore, the region PB is referred to as a “flame holding region”, and the region MB is referred to as an “unburned gas combustion region”. In addition, when the amount of the auxiliary fuel needs to be increased as compared with the amount supplied to the flame holding region PB in order to obtain the stable rotation state of the gas turbine engine or in order to increase the load of the gas turbine engine in response to the request of the machine equipment, such as the generator, connected to the turbine, as will described below, such an increment of the auxiliary fuel is supplied to the region MB together with the unburned gas.

With the configuration of the combustor 2 described above, since the flame is held in the flame holding region PB regardless of a change in a load state or a change in a state of the unburned gas, even when there is the change in the load state or the change in the state of the unburned gas, a blowout state in the combustion chamber is avoided. In addition, when the flame is held in the flame holding region PB, solely the auxiliary fuel having a large calorific value is substantially dispersed as the fuel in such a flame holding region PB, so that the auxiliary fuel ignites in a smaller amount as compared to a case where the auxiliary fuel is dispersed together with the unburned gas having a small calorific value, and the flame can be held. Therefore, by supplying the auxiliary fuel to the flame holding region PB such that solely the auxiliary fuel is substantially dispersed, the amount of the auxiliary fuel at the equivalent ratio optimized for flame holding can be further decreased (as compared to a case where the auxiliary fuel is dispersed together with the unburned gas). In addition, since solely the auxiliary fuel is dispersed in the flame holding region PB, the flame holding region PB can be designed and formed such that the equivalent ratio can be obtained such that the flame can be held in a state where the amount of the auxiliary fuel is decreased as small as possible, whereas since the increment of the auxiliary fuel in response to the load fluctuation of the gas turbine engine is supplied to the unburned gas combustion region MB, even in that case, the fuel in the flame holding region PB is not in a rich state, and it is also advantageous in that the stable combustion and the suppression of NOx or CO generation are achieved.

Control of Flow Rate of Auxiliary Fuel

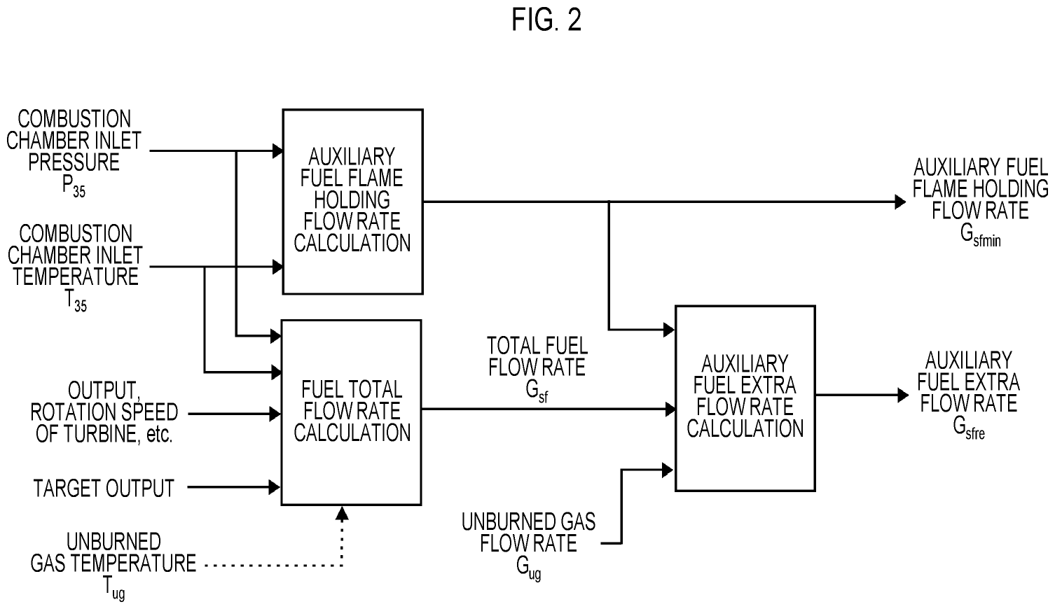

In the combustor 2 of the present embodiment described above, the unburned gas and the auxiliary fuel are supplied to the combustion chamber 12 as the fuel, in one aspect, the unburned gas is discharged from a discharge source thereof and then supplied as it is to the combustion chamber 12 from the unburned gas supply line 5, and regarding the auxiliary fuel, the flow rates (flame holding flow rate and extra flow rate) supplied to the flame holding region PB and the unburned gas combustion region MB, respectively, may be decided in the control device 50 in consideration of the operation state of the gas turbine engine in an aspect shown in the block diagram of FIG. 2. The control device 50 may include a fuel total flow rate calculation unit that decides a total fuel flow rate G_{sf} of the fuel in which the unburned gas and the auxiliary fuel are mixed supplied to the combustion chamber 12, an auxiliary fuel flame holding flow rate calculation unit that decides an auxiliary fuel flow rate (flame holding flow rate) G_{sfmin} supplied to the flame holding region PB, and an auxiliary fuel extra flow rate calculation unit that decides an auxiliary fuel flow rate (extra flow rate) G_{sfre} supplied to the unburned gas combustion region MB.

Specifically, with reference to FIG. 2, first, in the fuel total flow rate calculation unit, the total fuel flow rate G_{sf} of the fuel in which the unburned gas and the auxiliary fuel are mixed is decided such that the stable rotational operation in the gas turbine engine is achieved. In this regard, the total amount of the fuel supplied may be limited such that the temperature of the combustion chamber 12 is not excessively high. Therefore, specifically, the total fuel flow rate G_{sf} may be decided by monitoring the rotation speed and the output torque of the rotation shaft 3a of the turbine 3 and the temperature of the combustion chamber 12 such that the rotation of the turbine 3 is stable and the temperature of the combustion chamber 12 is not excessively high. Here, regarding the operation of the turbine 3, the output (load) of the turbine 3 may be course in response to combustion processing of the unburned gas, in that case, a target value (target output) of a rotation output of the turbine 3 may be a value at which the rotation of the turbine 3 is stable, and the needed amount of the fuel may be decided such that the rotation of the turbine 3 achieves such a target output. Alternatively, the output of the turbine 3 may fluctuate in response to the request of the machine equipment, such as the generator, connected to the rotation shaft 3a of the turbine 3, in that case, the needed amount of the fuel may be supplied with reference to the target output such that the output of the turbine 3 achieves the target value (target output) decided in response to the request of the machine equipment, such as the generator, by any method. In addition, since the temperature of the combustion chamber 12 is decided by adding the calorific value of the fuel to the calorific value of the compressed air at the inlet of the combustion chamber 12, the estimation can be made in consideration of the calorific value of the fuel flowing in the combustion chamber 12 from the temperature T₃₅ and the pressure P₃₅ of the compressed air measured at the inlet of the combustion chamber 12. Then, instead of directly measuring the temperature of the combustion chamber 12, as shown in FIG. 2, the total amount of the fuel supplied may be limited based on the temperature T₃₅ and the pressure P₃₅ of the compressed air at the inlet of the combustion chamber 12. In this regard, in a case where the unburned gas is supplied to the combustion chamber 12, the temperature of the combustion chamber 12 is higher as the temperature of the unburned gas itself is higher, and thus the total fuel flow rate G_{sf} supplied may be further decided with reference to the unburned gas temperature T_{ug} (in a case where the flow rate of the unburned gas is small, the influence of the unburned gas temperature T_{ug} is small, so that the reference may be omitted).

Next, regarding the auxiliary fuel flame holding flow rate G_{sfmin}, as described above, since solely the auxiliary fuel for flame holding is substantially supplied to the flame holding region PB, the auxiliary fuel flame holding flow rate G_{sfmin} may be decided so as to have the optimum equivalent ratio for flame holding in response to the amount of the compressed air flowing through the flame holding region PB. Since the amount of the compressed air flowing through the flame holding region PB can be decided based on the temperature T₃₅ and the pressure P₃₅ of the compressed air at the inlet of the combustion chamber 12, the auxiliary fuel flame holding flow rate G_{sfmin} may be decided in the auxiliary fuel flame holding flow rate calculation unit based on the temperature T₃₅ and the pressure P₃₅. In the embodiment, the map for deciding the auxiliary fuel flame holding flow rate G_{sfmin} for given the optimum equivalent ratio may be prepared by using the temperature T₃₅ and the pressure P₃₅ of the compressed air in advance by an experiment and the like as variables, and in the operation of the gas turbine engine, the auxiliary fuel flame holding flow rate G_{sfmin} may be provided by the map calculation by using the temperature T₃₅ and the pressure P₃₅ of the compressed air measured sequentially. The auxiliary fuel flame holding flow rate G_{sfmin} is decided to hold the flame, and the calorific value generated by the combustion of such a flow rate contributes as a part of the output of the gas turbine engine. As described above, since the auxiliary fuel flame holding flow rate G_{sfmin} is desirably as small as possible for saving of the usage amount of the auxiliary fuel, the stable combustion, and the suppression of NOx or CO generation, the auxiliary fuel flame holding flow rate G_{sfmin} may be the minimum amount needed for flame holding in the flame holding region PB, but may be an amount obtained by adding a predetermined amount (that can be appropriately set) to such a minimum amount as long as the action and effect of the present disclosure and a case of the minimum amount are approximately not affected.

The auxiliary fuel extra flow rate G_{sfre} supplied to the unburned gas combustion region MB is supplied to further supplement the needed calorific value in order to achieve a state where the turbine 3 generates the target output or a state where the turbine 3 is stably rotated such that the temperature of the combustion chamber 12 is not excessively high with respect to the calorific value obtained by the combustion of the auxiliary fuel flame holding flow rate G_{sfmin} in the flame holding region PB and the combustion of the unburned gas in the unburned gas combustion region MB. Therefore, the auxiliary fuel extra flow rate G_{sfre} may be given as will described below by using the total fuel flow rate G_{sf} to be supplied to the combustion chamber 12, the auxiliary fuel flame holding flow rate G_{sfmin}, and an unburned gas equivalent flow rate G_{ug}* that is converted in terms of the calorific value.

$${G}_{sfre} = {G}_{sf} - {G}_{sfmin} - {G}_{ug}^{*} \qquad ( 1 )$$

(The unburned gas equivalent flow rate G_{ug}* is a value obtained by multiplying the actual unburned gas flow rate G_{ug} by the calorific value per unit flow rate (auxiliary fuel calorific value/unburned gas calorific value).)

Therefore, in the auxiliary fuel extra flow rate calculation unit, as shown in FIG. 2, the auxiliary fuel extra flow rate G_{sfre} may be decided by the equation (1) with reference to the total fuel flow rate G_{sf} from the total fuel flow rate calculation unit, the auxiliary fuel flame holding flow rate G_{sfmin}, and the unburned gas flow rate G_{ug} from the fuel total flow rate calculation unit.

In the embodiment, the total fuel flow rate G_{sf}, the auxiliary fuel flame holding flow rate G_{sfmin}, and the auxiliary fuel extra flow rate G_{sfre} are sequentially calculated throughout the operation of the gas turbine engine, and a control command is given from the control device 50 to the pilot auxiliary fuel extra flow rate control valve 6a and the auxiliary fuel extra flow rate control valve 6b such that the auxiliary fuel is supplied from the pilot auxiliary fuel supply nozzle 13 and the auxiliary fuel and unburned gas supply nozzle 14 at the auxiliary fuel flame holding flow rate G_{sfmin} and the auxiliary fuel extra flow rate G_{sfre}, respectively. In the present embodiment, as described above, it should be understood that throughout the operation of the gas turbine engine, that is, even in the stable operation state in addition to when the engine is activated, solely the auxiliary fuel is supplied to the flame holding region PB at the auxiliary fuel flame holding flow rate G_{sfmin} and the flame is held in the flame holding region PB.

In the control of the flow rate of the auxiliary fuel described above, when the following equation are satisfied,

$${G}_{s f} - {G}_{sfmin} - {G}_{u g}^{*} = 0 \\ {G}_{sfmin} = {G}_{s f} - {G}_{u g}^{*} \qquad ( 2 )$$

a state where an engine driving force and the load are balanced and the rotation speed is maintained at a fixed value is a state where the unburned gas can be processed most efficiently. Then, in the control described above, in a case where the load of the engine is increased, such as a case where the power generation request or the load request is increased from a state of the equation (2), in order to maintain the rotation speed of the engine in response to the load, the flow rate of the fuel is calculated and output by a feedback control from a state of the engine, such as the rotation speed. Here, in the flame holding region PB, the equivalent ratio capable of holding the flame is suitably formed such that the auxiliary fuel flame holding flow rate is the minimum value, the combustion is not in the rich state, and NOx or CO generation can be suppressed as small as possible, and the auxiliary fuel extra flow rate G_{sfre} is supplied to the unburned gas combustion region instead of the flame holding region PB, even when the auxiliary fuel is increased or decreased, an optimum state of the flame holding region PB is maintained, a state where NOx or CO generation is suppressed as small as possible is maintained.

In the control of the flow rate of the auxiliary fuel described above, the unburned gas flow rate G_{ug} is not a value directly measured by the unburned gas supply line 5, but any amount having a correlation with the flow rate of the unburned gas may be measured and converted into the flow rate of the unburned gas, and the measured amount may be referred to. As such an amount, specifically, an operating rate of a furnace, an output of a target that discharges the unburned gas, or the like can be considered, and in a case where a composition of the unburned gas is changed, the amount of an unburned gas component may be referred to. For example, such a configuration may be applied in a case where the flow rate of the unburned gas cannot be measured in some factories.

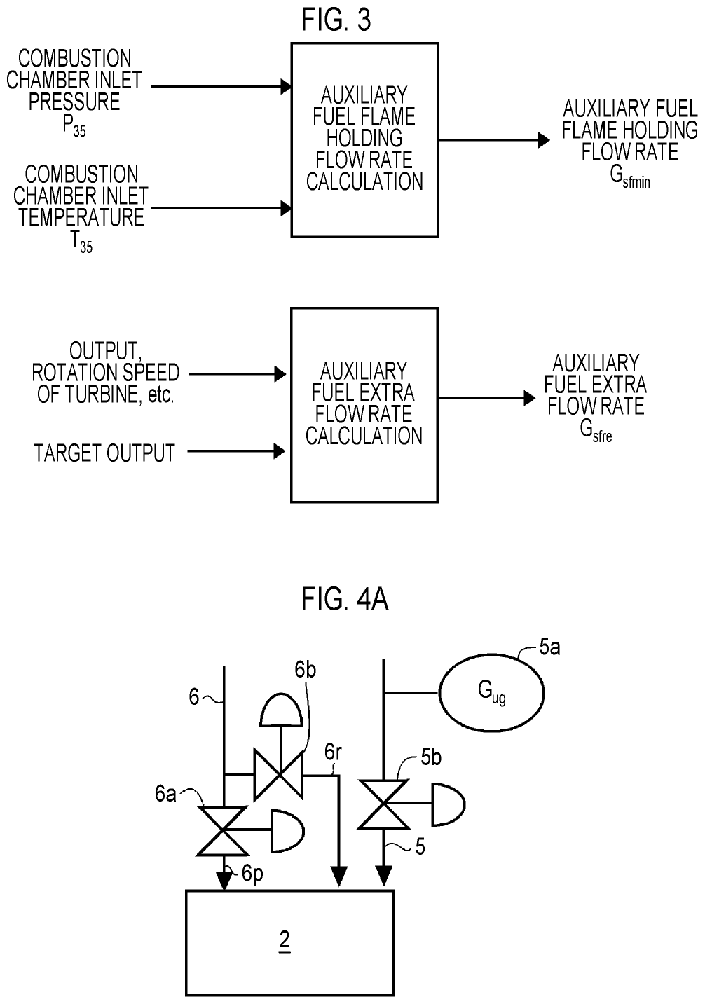

By the way, as can be understood from the block diagram of FIG. 2, the auxiliary fuel flame holding flow rate G_{sfmin} is decided based on the temperature and the pressure of the compressed air flowing in the combustion chamber 12 without referring to the operation state (rotation speed and the like) of the gas turbine engine, and the flow rate of the fuel that is adjusted to stabilize the operation state of the gas turbine engine or to fluctuate the load in response to the request from the machine, such as the generator, connected to the turbine is the auxiliary fuel extra flow rate G_{sfre}. In addition, in a case where an adjustment mechanism of the flow rate of the unburned gas is not provided as in another embodiment as will described below, the flow rate of the unburned gas is decided by the course from the discharge source. Therefore, the auxiliary fuel extra flow rate G_{sfre} may be substantially adjusted by the feedback control of the operation state of the gas turbine engine. Therefore, as shown in FIG. 3, the auxiliary fuel extra flow rate G_{sfre} may be adjusted with reference to output of the turbine, such as the turbine rotation speed or the torque, separately from the auxiliary fuel flame holding flow rate G_{sfmin} such that the target output is achieved. In this case, the change in the rotation state of the turbine due to the fluctuation of the flow rate of the unburned gas is absorbed by adjusting the auxiliary fuel extra flow rate G_{sfre}.

Mode in which Flow Rate of Unburned Gas can be Adjusted

Since the gas turbine engine according to the present embodiment has a main purpose of processing the unburned gas, the unburned gas generally flows in the combustion chamber 12 without adjusting the flow rate. However, in order to stabilize the operation state of the gas turbine engine or avoid overheating of the combustor, as schematically shown in FIG. 4A, the unburned gas flow rate control valve 5b may be provided as a unit that adjusts the flow rate of the unburned gas. In a case of a configuration in which the flow rate of the unburned gas is adjusted, in the control device 50, as shown in the block diagram of FIG. 4B, the total fuel flow rate G_{sf}, the auxiliary fuel flame holding flow rate G_{sfmin}, and the unburned gas flow rate G_{ug} are referred to in the auxiliary fuel extra flow rate calculation unit, and the auxiliary fuel extra flow rate G_{sfre} and an unburned gas supply amount (unburned gas control flow rate) G_{ugmax} to the combustion chamber 12 that is controlled in the unburned gas flow rate control valve 5b are decided. As described above, the auxiliary fuel extra flow rate G_{sfre} is decided by the equation (1), and for example, in a case where the unburned gas equivalent flow rate G_{ug}* is large and G_{sfre}<0 is satisfied, the unburned gas control flow rate G_{ugmax} may be decided such that G_{sfre}≥0 is satisfied (in a case where G_{sfre}<0 is satisfied, G_{sf}<G_{sfmin}+G_{ug}* is satisfied, the sum of the auxiliary fuel flame holding flow rate G_{sfmin} and the unburned gas flow rate G_{ug} exceeds the total fuel flow rate G_{sf} that is decided in consideration of the stabilization of the operation state of the gas turbine engine or the avoidance of overheating of the combustor, and thus the flow rate of the unburned gas supplied to the combustion chamber 12 is limited). Then, the control command may be given to the unburned gas flow rate control valve 5b from the control device 50 such that the flow rate of the unburned gas actually supplied to the combustion chamber 12 becomes the unburned gas control flow rate G_{ugmax}.

Therefore, in the present embodiment described above, the combustor is configured to execute the combustion processing of the unburned gas and supply, in the gas turbine engine that recovers the calorific value, the auxiliary fuel supplied to the combustion chamber 12 to stabilize the operation state thereof to separate regions respectively at the flow rate for flame holding in the combustion chamber and the flow rate for achieving the operation state in response to the load fluctuation. With such a configuration, the amount of the auxiliary fuel for flame holding can be decreased as small as possible and the stable operation state of the gas turbine engine can be achieved in response to the load fluctuation, and thus the effective use of the resource and the decrease in the running cost can be expected.

Although the above description has been made in connection with the embodiments of the present disclosure, it is clear that many modifications and changes can be easily made by those skilled in the art, and an applicable embodiment of the present disclosure is not limited to solely the embodiments described above and applied to various devices without departing from the concept of the present disclosure.

What is claimed is:

1. A combustor of a gas turbine engine in which unburned gas and an auxiliary fuel are supplied and combusted, the combustor comprising:
a combustion chamber in which the unburned gas, the auxiliary fuel, and compressed air are supplied, and the unburned gas and the auxiliary fuel are combusted;
a pilot fuel supply unit configured to supply solely the auxiliary fuel to a flame holding region in the combustion chamber;
a first auxiliary fuel amount adjustment unit configured to adjust an amount of the auxiliary fuel supplied from the pilot fuel supply unit;
a main fuel supply unit configured to supply the unburned gas and the auxiliary fuel to an unburned gas combustion region in the combustion chamber continuous with the flame holding region; and
a second auxiliary fuel amount adjustment unit configured to adjust an amount of the auxiliary fuel supplied from the main fuel supply unit,
wherein the first auxiliary fuel amount adjustment unit is configured to adjust the amount of the auxiliary fuel supplied from the pilot fuel supply unit to an amount for flame holding in the flame holding region throughout an operation of the gas turbine engine.

2. The combustor according to claim 1, wherein the amount of the auxiliary fuel needed for flame holding in the flame holding region is decided based on a pressure and a temperature of the compressed air at an inlet in the combustion chamber.

3. The combustor according to claim 1, wherein the amount of the auxiliary fuel supplied from the pilot fuel supply unit is a minimum amount needed for flame holding in the flame holding region or an amount obtained by adding a predetermined amount to the minimum amount.

4. The combustor according to claim 1, wherein the amount of the auxiliary fuel supplied from the main fuel supply unit is an amount obtained by subtracting the amount of the auxiliary fuel supplied from the pilot fuel supply unit from a total amount of the auxiliary fuel to be supplied to the combustion chamber.

5. The combustor according to claim 4, wherein the total amount of the auxiliary fuel to be supplied to the combustion chamber is a fuel amount equivalent to a calorific value obtained by subtracting a calorific value of the unburned gas supplied from the main fuel supply unit from a total calorific value of a fuel to be supplied to the combustion chamber.

6. The combustor according to claim 1, wherein the amount of the auxiliary fuel supplied from the main fuel supply unit is increased or decreased in response to a load of the gas turbine engine.

7. The combustor according to claim 1, wherein an amount of the unburned gas supplied from the main fuel supply unit is estimated from a parameter having a correlation with a flow rate of the unburned gas.

8. The combustor according to claim 1, further comprising unburned gas adjustment unit configured to adjust an amount of the unburned gas supplied from the main fuel supply unit.

9. The combustor according to claim 1, wherein the unburned gas combustion region surrounds the flame holding region in the combustion chamber.
